(19) United States
(12) Patent Application Publication
(10) Pub. No.: US 2003/0123638 A1
(43) Pub. Date: Jul. 3, 2003

(54) Multi-application operations management for single system environments

(76) Inventor: Warner Lee Hines, Southlake, TX (US)

Correspondence Address: CONLEY ROSE, P.C., P. O. BOX 3267, HOUSTON, TX, 77253-3267, US

(21) Appl. No.: 10/034,719

(22) Filed: Dec. 28, 2001

(51) Int. Cl. H04M 7/00

(52) U.S. Cl. 379/229

(57) ABSTRACT

As the complexity of communication networks, such as the Public Switched Telephone Network or PSTN, has increased, the network management operations have become more complex as well. In particular, as the complexity of the devices used in communications networks has increased, advanced network management operations have been developed in order to ensure continued efficient and reliable network performance. The present invention provides a method and system for utilizing the enhanced processing capability on Intelligent Network Servers, INSs, to perform enhanced operations management of local applications and to provide unified reporting of the INS status and performance to network operations management in a manner similar to other network devices or nodes in the network.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to providing unified and integrated operation management and reporting capabilities for multiple applications executing in a single-system environment. More specifically, the invention relates to a system and method for providing uniform integrated operation management and reporting capabilities for an Intelligent Network Server (INS) handling multiple network applications.

2. Background of the Invention

The Public Switched Telephone Network, or PSTN, as we know it today was developed to allow telephone calls to be made to and from points anywhere in the world. To do this efficiently standards have been developed to perform, maintain, and manage the various switches and other network devices used to accomplish the tasks of handling these calls. One of the most important of these standards is the SS7 protocol, Signaling System 7, which defines the procedures and protocol by which network elements in the PSTN exchange information over a digital signaling network to effect wireless (cellular) and wireline call setup, routing, and control. The SS7 standard was originally developed to allow signaling for large numbers of calls to be sent over a small number of telephone lines, thereby reserving more lines or bandwidth for the voice connections. However, the SS7 standard has also facilitated the development of many other value-added functions on the PSTN, such as 800 service, 900 service, 911 service, mobile telephone service, position determination service for mobile telephones, etc.

Originally, SS7 was used in the PSTN when the primary network devices of the PSTN were telephone switches. These switches were essentially hardwired systems which used the signaling information from the SS7 system to build the connections between two or more telephone sets. The switches, however, were not well suited for “non-standard” value-added applications, functions or services, such as 800 service, since the switches were difficult to modify.

The inflexibility of these switches was addressed by adding Service Control Points, SCPs, to the PSTN. Each SCP is identified by a Signaling Point Code, SPC, often referred to as simply the Point Code, PC. An SS7 message could be directed to a specific SCP by embedding the correct PC in the SS7 message. Essentially, the SS7 message could be addressed to the correct SCP using the PC identified with that SCP. Initially, each SCP was typically designed to handle one specific value-added service or application, such as 800 service. So, a particular Point Code was identified with a specific SCP which in turn was identified with a specific service or application.

The SCPs often were essentially databases needed, for example, to convert an 800 number to a standard phone number which a switch could then use to make the desired connection. When a switch received an 800 number, for example, it would simply forward the SS7 message to the point code of the SCP providing 800 service. The SCP would then look up the standard phone number and, using an SS7 message, return it to the switch which then completed the call. By maintaining the 800 service database in the SCP, any change to the 800 service could be implemented by changing the database in the SCP as opposed to changing the telephone switches.

As the number and complexity of telephone services increased, the SCPs were upgraded to include more and more intelligence. Many SCPs now are computer servers capable of handling many applications necessary to provide the various telephone services or functions. These applications are essentially controlled by computer programs on the intelligent SCP. An intelligent SCP may be referred to as an Intelligent Network Server, INS. An INS is generally capable of handling many applications to provide enhanced functionality for individual services or to handle multiple services.

An INS running multiple applications for multiple services creates some new issues for the standard SS7 telephone system to handle. For instance, an INS has a single point code, PC, since it is a single point or node on the network. However, when the INS has multiple applications handling multiple telephone services, the point code can no longer be used to identify each application. When an SCP handled only one application, the point code for the SCP could be used to send SS7 messages to that application. For an INS with multiple applications, however, there is no such one to one correspondence. The INS contains a number of applications which all therefore are identified by the same point code, the point code of the INS. Thus, there is a problem in trying to send SS7 messages to specific applications on the INS. This problem has been addressed by identifying each application on the INS with a Subsystem Number, SSN. An SS7 message to a particular network service therefore contains both the point code and the SSN for the particular application or subsystem needed. When all of the SCPs follow this protocol, messages can be sent to and from any of the subsystems or applications at any of the point codes in the PSTN, whether an INS handling multiple applications or an SCP handling only one application.

Although this issue of addressing multiple applications on a single INS has been effectively resolved, there are other similar issues arising from the grouping of multiple applications on a single node in the network, i.e., on an INS. For instance, how to handle network operations management when individual points on the network have multiple applications running which provide multiple services for the network.

Again, when the SCPs were running a single application or performing a single function, network operations were simplified since the performance and operation of a single SCP, or node on the network, directly correlated to the performance and operation for the application that SCP was handling. For instance, the operation of the 800 service for the network could be monitored and managed by simply monitoring the SS7 traffic to the node or the SCP responsible for the 800 service, or by simply requiring some form of SCP reporting, such as a status message, from the SCP. With today's INSs, however, the 800 service as well as multiple other applications or services may be handled at a single node. Or alternatively, the 800 service may rely on applications residing on several INSs. Thus, the service may effectively be split across several nodes. The result is that operation management for the service can not be accomplished by simply monitoring, managing, or receiving information from a single node. Moreover, the status of a particular node, from a management perspective, is difficult to correlate to the status of the network functions or applications, since multiple applications may be being performed on the node.

To date, network operations management has typically been handled by consolidation of the operations management functions at a higher-order layer. More particularly, management “protocol” techniques have been implemented that roll management state information for the various telephone services, and SCPs or INSs running the applications for those services, to higher-order network management systems, such as SNMP, CORBA, CMIS/CMIP. Although these systems can provide enhanced means of monitoring the more sophisticated applications running across the SCPs or INSs, these systems typically expect or require status information for each of the individual services or applications, or alternatively, from each node in the network. This becomes increasing complex with multiple applications running on individual nodes. Consolidating the operations management of the various applications requires coalescent application management environments requiring great care and planning to avoid having disparate techniques for application management and reporting capabilities for the various applications or nodes.

Additionally, these operation management systems are typically remote from the elements being managed. That is, the consolidated operations management function is run at a location in the network remote from the nodes, SCPs and INSs, running the applications. This creates certain inefficiencies. By distancing the operations management from the applications, the network management tasks create overhead to the network. That is, the network operations management tasks use bandwidth in the system to accomplish their communication to the remote SCPs and INSs running the applications. In addition, communications with the remote applications is inherently at network speeds, typically much slower than intra-system level communications. As a result, the operations management can not be as dynamically reactive to the transaction-level operations of the applications.

### BRIEF SUMMARY OF THE INVENTION

The present invention provides a method and system for utilizing the enhanced processing capabilities of an INS to provide unified and integrated network operations management. The operations management is performed within the same system or INS as the applications thereby allowing management to be provided at the transaction-level of the applications. With this, impact analysis and reactive behavior are performed based upon dynamic values against the equally dynamic transaction setting resulting in enhanced operations management of the local applications. In addition, the integrated operations management provides uniform reporting capabilities for the INS applications, or network node, regardless of the type or quantity of applications being performed on the INS.

In an embodiment of the present invention, the intelligent network server comprises a message transport module for receiving messages from a communications network (which may be the public switched telephone network or PSTN); at least one subsystem coupled to the message transport module, running an application for performing network services or functions; an operations management module coupled to the message transport module and the at least one subsystem, performing local operations management for the application. Alternatively, the intelligent network server may comprise a plurality of subsystems coupled to the message transport module, running a plurality of applications for performing network services or functions, wherein the operations management module performs local operations management for the plurality of applications.

In alternate embodiments, the operations management module reports a unified status of the intelligent network server via the message transport module, monitors events for the application, creates an event log recording the history of events for the application, processes the events of the applications to determine the status of the application, processes the events of the application using predetermined performance characteristics for the application to determine the status of the application, determines the individual status of each of the plurality of applications, identifies when a fault or error condition for the application may occur or is occurring, initiates corrective measures to avoid a fault or error condition for the application or to enhance performance of the application, such as routing network messages to another application, and/or homogenizes the individual status of each of the applications to determine a unified status of the intelligent network server. The unified status is generally indicative of the overall status of the intelligent network server and is reported in the same manner as the status of any other network device or node in the network. Creation of the unified status can be facilitated by using uniform criteria to indicate the status of each of the applications. The unified status may be reported to network operations management performed on a network device remote from the intelligent network server. The local operations management may be integrated with the transactions-level processing of the applications.

In an alternate embodiment of the invention, a network system comprises a communications network; an intelligent network server coupled to the communications network performing local operation management for subsystems on the intelligent network server; and a network operations management device coupled to the communications network. The local operations management on the intelligent network server reports a unified status message to the network operations management, where the message is indicative of the overall status of the subsystems on the intelligent network server. The message is reported in the same manner as the status of any other network device or node in the network. The message may be an SS7 message.

In an alternate embodiment of the invention, a method of performing operations management on an intelligent network server comprises performing local operations management for multiple applications on an intelligent network server; and reporting a unified status for the intelligent network server to network operations management. The unified status is determined from the individual status of each of the applications running on the intelligent network server and is reported in the same manner as the status of any other network device or node in the network. Performing local operations management comprises monitoring events of each application; processing the events using predetermined performance criteria for the applications; and determining the individual status of each application. The method may further comprise homogenizing the individual status of each application into the unified status for the intelligent network server. The network operations management may be performed on a network device remote from the intelligent network server.

### BRIEF DESCRIPTION OF THE DRAWINGS

For a detailed description of the preferred embodiments of the invention, reference will now be made to the accompanying drawings in which:

FIG. 1 is a system diagram of a typical PSTN-type network illustrating individual nodes on the network handling specific network functions and services including remote operations management.

FIG. 2 is a system diagram of a PSTN-type network pursuant to the present invention illustrating individual nodes on the network handling various and potentially multiple network functions and services including remote operations management;

FIG. 3 is a system diagram illustrating an intelligent SCP, or an Intelligent Network Server (INS), having integrated operations management pursuant to the present invention; and

FIG. 4 is a flow chart illustrating the method of performing integrated operations management as contemplated by the present invention.

### NOTATION AND NOMENCLATURE

Certain terms are used throughout the following description and claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first device couples to a second device, that connection may be through a direct connection, or through an indirect connection via other devices and connections.

### DETAILED DESCRIPTION OF THE PREFERRED EMBODIMENTS

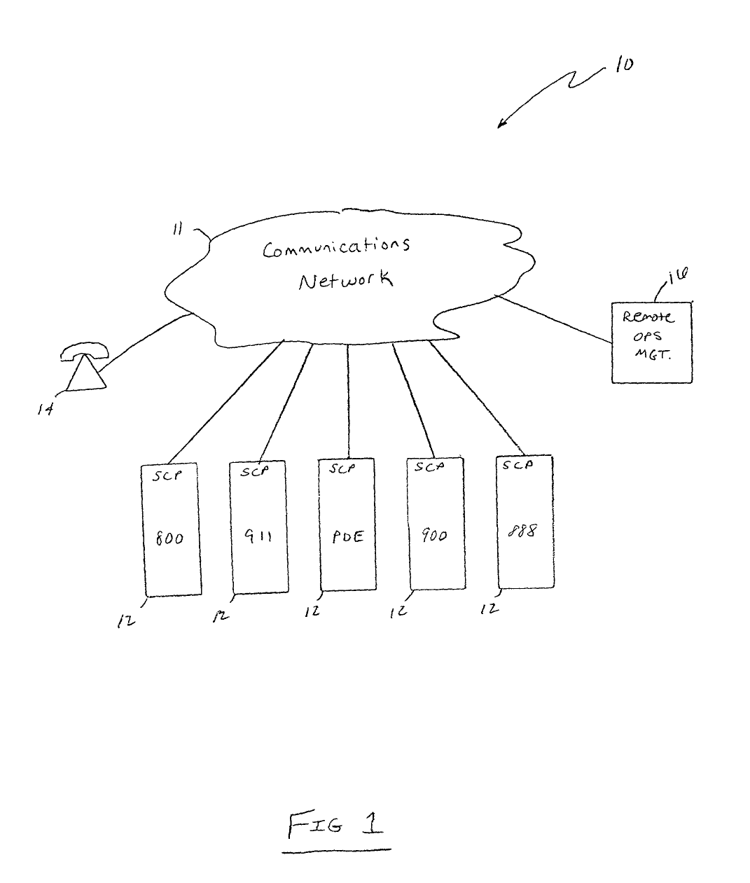

FIG. 1 is a system diagram of a simplified Public Switched Telephone Network, PSTN network, 10 illustrating individual network devices or nodes on the network handling specific network functions and services including remote operations management. More specifically, FIG. 1 illustrates a PSTN network 10 comprising a communications network 11 coupled to multiple network devices. The network devices include Service Control Points, SCPs, 12 which are coupled to the communications network 11. The SCPs handle applications for a specific network function or service; for example, 800 service, 900 service, 911 service, mobile telephone service (mob), position determination service for mobile telephones (PDE), etc. A POTS telephone 14 is shown coupled to the communications network 11 to initiate actual telephone calls. A remote operations management device 16 is coupled to the communications network 11 to handle operations management and control functions. As shown in FIG. 1, the operations management device 16 is remote from the SCPs 12 performing the applications for the network services and functions. The operations management device 16 typically also resides at or on a separate SCP or node in the PSTN network 10.

In the PSTN network 10 of FIG. 1 each SCP 12 is designed to handle a single service or function. Accordingly, as discussed above, the communications between the functions on the SCPs 12 can be handled by simply addressing the SS7 messages to the functions with the appropriate point code for the specific SCP 12 performing the function or service. Similarly, operations management for the PSTN network 10 is simplified. Since each network device or node in the network performs a specific function, the operations management device 16 can monitor and control the operations of the services and functions by simply monitoring and controlling the actual SCPs 12 or nodes in the network handling each service or function. For example, by monitoring the traffic to and from a particular SCP 12, the operations management device 16 could determine the relative load on the SCP 12 as a node in the PSTN network 10. To the extent the PSTN network 10 includes multiple or repetitive SCPs providing the same function or service, the operations management device 16 could route calls requiring that service or function to another SCP 12 or node in the PSTN network 10 having a lower load condition and thus faster or better performance.

Since the operations management device 16 is remote from the SCPs 12, any communication between the module 16 and the SCPs 12 would occur across the communications network 11. As a result, the amount and type of interaction between the module 16 and SCP 12 may be limited to conserve network bandwidth. In addition, such communications would occur at the relatively slow network speeds, as compared to intra-system speeds of communication.

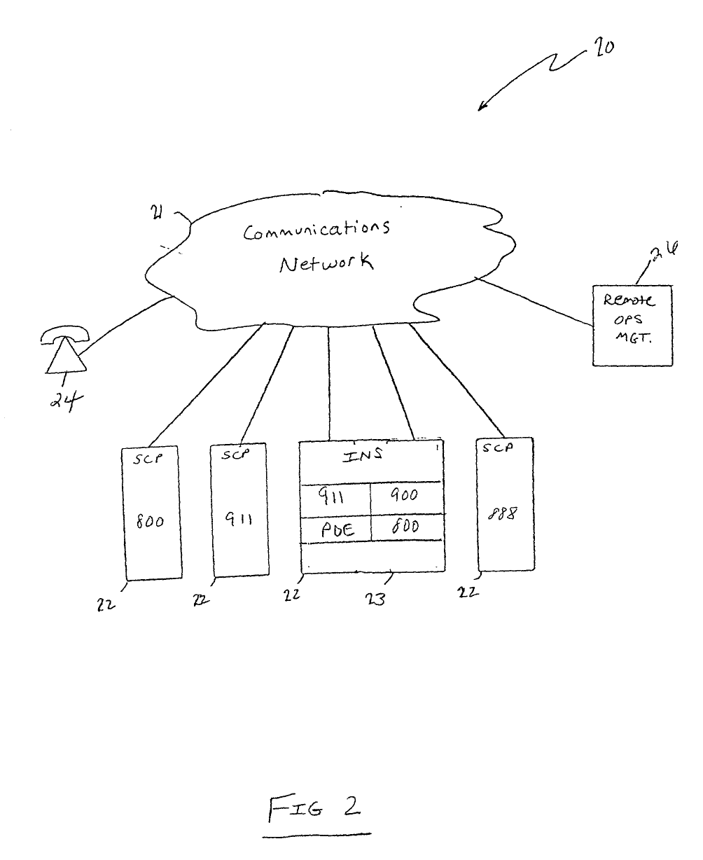

FIG. 2 is a system diagram of a PSTN network 20 pursuant to the present invention illustrating individual nodes on the network 20 handling various and potentially multiple network functions and services including remote operations management. More specifically, FIG. 2 illustrates a PSTN network 20 comprising a communications network 21 coupled to multiple network devices. The network devices include Service Control Points, SCPs, 22 which are coupled to the communications network 11 to handle applications for a specific network function or service; for example, 800 service, 900 service, 911 service, mobile telephone service, position determination service for mobile telephones, etc. Also shown in FIG. 2 is an intelligent SCP or Intelligent Network Server, INS, 23 capable of handling multiple applications for network services and functions at a single node in the network. A POTS telephone 24 is shown coupled to the communications network 21 to initiate actual telephone calls. A remote operations management device 26 is coupled to the communications network 21 to handle operations management and control functions. As shown in FIG. 2, the remote operations management device 26 is remote from the SCPs 22 and INS 23 that perform the applications for the network services and functions. The remote operations management device 26 typically also resides at or on a separate SCP 22 or node in the PSTN network 20.

In the PSTN network 20 of FIG. 2 each node in the network is no longer handling a single service or function. In particular, the INS 23 is capable of handling multiple applications for services and functions. As indicated in FIG. 2, INS 23 is handling 800 service, 911 service and PDE service. As a result, the operations management for the PSTN network 20 is more complex. Since each network device or node in the network no longer performs a single specific function or service, the operations management device 26 can not monitor and control the operations of the services and functions by simply monitoring and controlling the actual SCPs 22 or nodes in the network handling each service or function. More specifically, since there is no longer a one-to-one correspondence between the network services and functions with the network devices or nodes on the network, the operations management device 26 can not determine the status of a particular function or service by simply monitoring the traffic to and from a particular SCP 22 or node in the network.

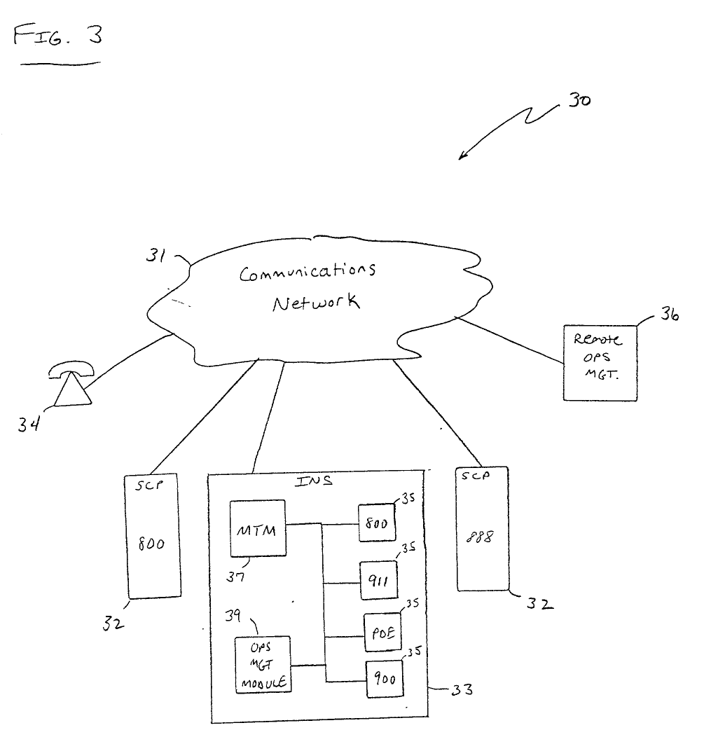

FIG. 3 is a system diagram illustrating an intelligent SCP, or an Intelligent Network Server (INS), 33 having integrated operations management pursuant to the present invention. More specifically, FIG. 3 illustrates a PSTN-type network 30 comprising a communications network 31 coupled to multiple network devices. The network devices include Service Control Points, SCPs, 32 which are coupled to the communications network 31 to handle applications for a specific network function or service. A POTS telephone 34 is shown coupled to the communications network 31 to initiate actual telephone calls. A remote operations management device 36 is coupled to the communications network 31 to handle network operations management and control functions. As shown in FIG. 3, the remote operations management device 36 is remote from the SCPs 32 and INS 33 that perform the applications for the network services and functions. The remote operations management device 36 typically also resides at or on a separate SCP 32 or node in the PSTN network 30.

FIG. 3 shows more detail of an intelligent SCP or Intelligent Network Server, INS, 33. The INS 33 is capable of handling multiple applications for network services and functions at a single node in the network. The INS 33 is typically a computer system, with one or more computers or computer servers, having the processing capacity to handle multiple applications. As shown in FIG. 3, the INS 33 includes multiple subsystems 35. Each subsystem handles a specific application for a network function or service as shown, i.e., 800 service 911 service, 900 service, PDE, etc. Network signaling messages are received and sent by the INS 33 via its Message Transport Module, MTM, 37. In a PSTN network, the messages between the INS 33 and communications network 31 would conform to SS7 protocol, i.e., SS7 messages. The SS7 messages can be directed to each of the applications performing network functions or services on the INS 33 by addressing the message to a particular subsystem 35 on the INS 33. Each subsystem 35 has a unique Subsystem Number, SSN, associated with it. By including the SSN in the SS7 message, the message can be directed to a specific subsystem 35 on the INS 33 handling a specific application for a network service or function.

As shown in FIG. 3, the INS 33 also incorporates a subsystem for handling integrated operations management. The operations management module 39 is integrated into or on the INS 33 and is coupled to the subsystems 35 and message transport module 37. The operations management module 39 performs management and control functions for the applications on the INS 33 that perform the network services and functions. Taking advantage of the processing capacity of the INS 33, the operations management module 39 performs operations management tasks relating to the network services and functions being performed by the local subsystems 35. Since the operations management module 39 is on the same system or platform with the subsystems 35, the operations management tasks can be performed more efficiently. The communications between the operations management module 39 and the subsystems 35 can be performed at intra-system communication speeds as opposed to network speeds for remote operations management. Moreover, the operations management tasks performed by module 39 can be integrated directly into the message or transaction processing of the INS 33. Management can be provided at the transaction-level of the applications performing the network services and functions. With this, impact analysis, reactive behavior, and other operations tasks can be performed based upon more dynamic values against the equally dynamic transactions setting. In this way, the local integrated module 39 allows for enhanced, more dynamic operations management and control to be performed.

Given that the INS 33 is still operating within the PSTN network 30 which includes other SCPs 32, however, the INS 33 must still report and comply with the remote operations management for the network 30 as a whole. Accordingly, the INS 33 must report event and/or other status or performance information for the INS 33 to the remote operations device 36, just as any other end-point or node in the network 30. To provide a unified representation of the overall status of the INS 33 is complicated by the fact that there are multiple applications on the INS 33 handling multiple network services and functions. Accordingly, one of the tasks of the local operations management module 39 is to gather and process the status of the individual subsystems, and thus the status of the applications which they are running, then to process that information to determine and report an overall status or performance of the INS 33. In the preferred embodiment of this invention, this is accomplished by using interlocking subsystems for events, overloads, and statistics at the transaction layer of the intelligent networking solution, a Compaq Himalaya INS in the preferred embodiment. In this manner, management is no longer a “layer” to the solution set but is instead a behavior of the overall transaction processing of the INS system. Since the operation management tasks are performed as part of the transaction processing, the management is a dynamic real-time function of the system. Using standard or customized network management protocols, the events and operations can be monitored, statistics and thresholds can be used to evaluate the operations, and conditions such as overloads can be identified. In the preferred embodiment, the operations management module 39 incorporates a trio of real-time operations subsystems for events, statistics, and overload capability.

In the embodiment of the invention as shown in FIG. 3, the unified message of the INS 33 status as a node in the network would be reported from the local operations management module 39 via the message transport module 37, across the communications network 31, to the remote operations management device 36, using an SS7 message in a PSTN network. It is to be understood that although the embodiments of the invention described and shown herein reference a PSTN network, the invention is not necessarily limited to a PSTN network. Any network expecting health status messages from network devices, or nodes in the network, in order to perform network operations management could similarly benefit from the integrated operations management on a network device as described herein, particularly where some of those network devices or nodes perform multiple applications or functions.

It should also be recognized that some network functions or services may require several applications to support them and that these applications may reside on different network devices or nodes in the network. For example, a 911 call from a mobile phone may require the initiation of both a 911 application and a PDE application to determine the location of the phone caller to assist an emergency response to the caller. It is possible for the 911 service and the PDE to be located on different INSs or even in part on an SCP. To the extent these services need to communicate with one another, they can do so by standard SS7 messaging. This can further complicate, however, the task of operation management for this service.

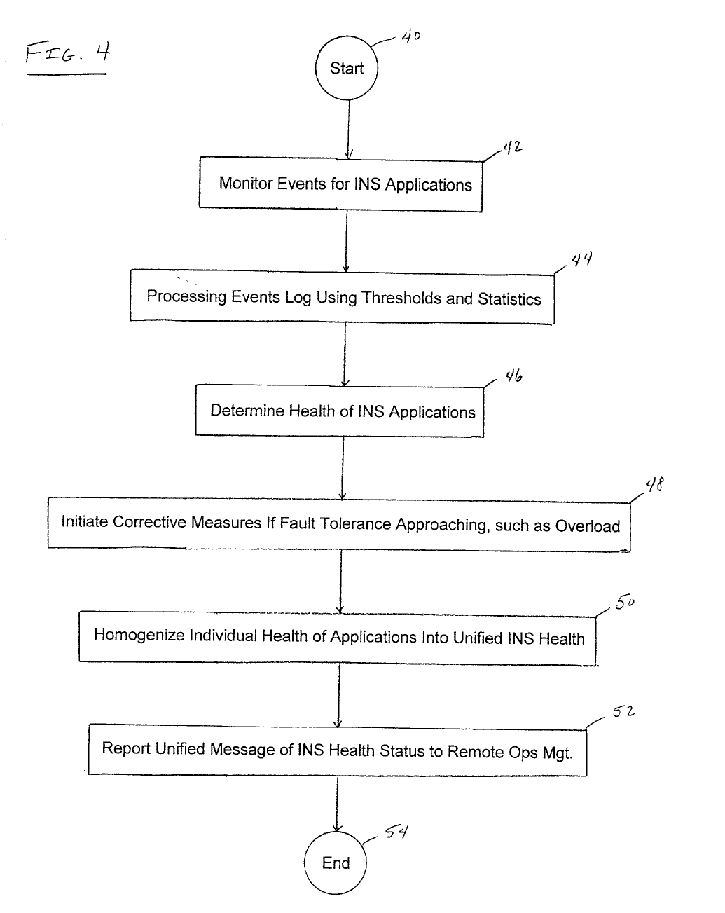

FIG. 4 is a flow chart illustrating the method of performing integrated operations management as contemplated by the present invention. The process starts with block 40. As the INS 33 performs its typical message or transaction processing, the local operations management module 39 monitors the transactions or events for each of the various INS applications being performed for the multiple network services and functions handled by the INS 33, as indicated in block 42. These events are typically recorded or stored in memory, typically as an event log. In block 44, the events log is processed using statistics and thresholds. Using these various statistical calculations and thresholds in relation to the history of events for each of the INS applications, the health of each of the INS applications can be determined, see block 46. For instance, by tracking the number of messages received by an application and then the time to respond to those messages, the performance of the application can be determined. Based on the determination of the health of each application, and knowing certain predetermined performance criteria for the system or application being performed, such as fault tolerances, overload conditions, typical processing time, etc., the local operations management module 39 can initiate certain corrective measures to avoid a fault or error condition for the application, or perhaps simply to enhance performance of the network services or functions being performed by routing network services to other applications, see block 48. As indicated in block 50, knowing the health of the individual applications running on the INS 33 allows the local operations management module 39 to homogenize those health conditions into a unified health status for the INS 33 as a whole. This is assisted by using uniform criteria for the health condition of each application. That is, to the extent the health of each application has been represented in a similar and consistent fashion, it is then easier to correlate that data for all applications to determine a unified status for the INS 33 as a whole. Finally, in block 52, the local operations management module 39 reports a unified message for the health or performance status of the INS to the remote operations management device 36. This unified INS report is indicative of the overall status of the INS and is reported in the same manner as any other network device or node in the network, whether an INS 33 running multiple applications or an SCP running only one application. Again, this uniform reporting facilitates the network management performed by the remote operations management. To the remote operations management device 36, the INS appears to be just another singular network device. The process ends at block 54.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An intelligent network server, comprising:
a message transport module for receiving messages from a communications network;
at least one subsystem coupled to the message transport module, running an application for performing network services or functions;
an operations management module coupled to the message transport module and the at least one subsystem, performing local operations management for the application.

2. The intelligent network server of claim 1 comprising a plurality of subsystems coupled to the message transport module, running a plurality of applications for performing network services or functions.

3. The intelligent network server of claim 2 wherein the operations management module performs local operations management for the plurality of applications.

4. The intelligent network server of claim 1 wherein the operations management module reports a unified status of the intelligent network server via the message transport module.

5. The intelligent network server of claim 2 wherein the operations management module monitors events for the application.

6. The intelligent network server of claim 5 wherein the operations management module creates an event log recording the history of events for the application.

7. The intelligent network server of claim 5 wherein the operations management module processes the events of the applications to determine the status of the application.

8. The intelligent network server of claim 5 wherein the operations management module processes the events of the application using predetermined performance characteristics for the application to determine the status of the application.

9. The intelligent network server of claim 3 wherein the operations management module determines the individual status of each of the plurality of applications.

10. The intelligent network server of claim 1 wherein the operations management module initiates corrective measures to avoid a fault or error condition for the application or to enhance performance of the application.

11. The intelligent network server of claim 10 wherein the corrective measures comprise routing network messages to another application.

12. The intelligent network server of claim 9 wherein the operations management module homogenizes the individual status of each of the applications to determine a unified status of the intelligent network server.

13. The intelligent network server of claim 4 wherein the unified status is indicative of the overall status of the intelligent network server.

14. The intelligent network server of claim 4 wherein the unified status is reported in the same manner as the status of any other network device or node in the network.

15. The intelligent network server of claim 9 wherein uniform criteria is used to indicate the status of each of the applications.

16. The intelligent network server of claim 1 wherein the operations management module identifies when a fault or error condition for the application may occur or is occurring.

17. The intelligent network server of claim 1 wherein the network is a public switched telephone network or PSTN.

18. The intelligent network server of claim 4 wherein the unified status is reported to network operations management.

19. The intelligent network server of claim 18 wherein the network operations management is performed on a network device remote from the intelligent network server.

20. The intelligent network server of claim 1 wherein the local operations management is integrated with the transactions-level processing of the applications.

21. A network system, comprising:
a communications network;
an intelligent network server coupled to the communications network performing local operation management for subsystems on the intelligent network server; and
a network operations management device coupled to the communications network.

22. The network of claim 21 wherein the local operations management on the intelligent network server reports a unified status message to the network operations management, where the message is indicative of the overall status of the subsystems on the intelligent network server.

23. The network of claim 22 wherein the message is reported in the same manner as the status of any other network device or node in the network.

24. The network of claim 22 wherein the message is an SS7 message.

25. An intelligent network server comprising:
means for performing operations management for multiple applications on an intelligent network server; and
means for reporting a unified status for the intelligent network server to network operations management.

26. A method of performing operations management on an intelligent network server, comprising:
performing local operations management for multiple applications on an intelligent network server; and
reporting a unified status for the intelligent network server to network operations management.

27. The method of claim 26 wherein the unified status is determined from the individual status of each of the applications running on the intelligent network server.

28. The method of claim 26 wherein the unified status is reported in the same manner as the status of any other network device or node in the network.

29. The method of claim 26 wherein performing local operations management comprises:
monitoring events of each application;
processing the events using predetermined performance criteria for the applications; and
determining the individual status of each application.

30. The method of claim 29 further comprising homogenizing the individual status of each application into the unified status for the intelligent network server.

31. The method of claim 26 wherein the network operations management is performed on a network device remote from the intelligent network server.
